(19) United States
(12) Patent Application Publication
(10) Pub. No.: US 2024/0320028 A1
(43) Pub. Date: Sep. 26, 2024

(54) APPARATUS AND METHOD FOR VIRTUAL DEVICE MIRRORING BETWEEN EDGES

(71) Applicant: ELECTRONICS AND TELECOMMUNICATIONS RESEARCH INSTITUTE, Daejeon (KR)

(72) Inventors: Dong-Beom KO, Seoul (KR); Sung-Joo KANG, Daejeon (KR); In-Geol CHUN, Daejeon (KR)

(73) Assignee: ELECTRONICS AND TELECOMMUNICATIONS RESEARCH INSTITUTE, Daejeon (KR)

(21) Appl. No.: 18/586,329

(22) Filed: Feb. 23, 2024

(30) Foreign Application Priority Data
Mar. 22, 2023 (KR) 10-2023-0037049

(51) Int. Cl. G06F 9/455; H04L 67/1095

(52) U.S. Cl. CPC G06F 9/45558; H04L 67/1095; G06F 2009/45562; G06F 2009/45583

(57) ABSTRACT

Disclosed herein are an apparatus and method for virtual device mirroring between edges. An edge server includes memory configured to store at least one program and a processor configured to execute the program, wherein the program is configured to create a virtual device based on specification information of an actual device and provide the specification information used to create the virtual device in response to a request received from an additional edge server, or acquire specification information used to create a virtual device of the additional edge server in response to a request of the actual device and create a virtual device based on the acquired specification information, wherein the virtual device synchronizes data with the actual device and the virtual device of the additional edge server in real time.

### CROSS REFERENCE TO RELATED APPLICATION

This application claims the benefit of Korean Patent Application No. 10-2023-0037049, filed Mar. 22, 2023, which is hereby incorporated by reference in its entirety into this application.

### BACKGROUND OF THE INVENTION

### 1. Technical Field

The following embodiments relate to technology for transmission/reception between edge devices in an edge computing environment.

### 2. Description of the Related Art

As requirements for contactless services increase due to the pandemic, metaverse services such as virtual meeting rooms are emerging. In order to enhance user immersion in a virtual environment where multiple users coexist simultaneously, there is required technology for supporting interaction between users or between a user and an object in a virtual environment by utilizing a multimodal interface such as haptic feedback.

In a virtual space, users can experience interaction thereamong through elements such as voice and gestures, or can experience interaction with digitized objects of real objects in the virtual space through visual, auditory, and tactile sensations. However, in order to provide higher-level immersion, technology for guaranteeing a higher response speed for the multimodal interface of a user is required.

In response to such a low-latency response request, research into a low-latency support method through edge computing technology has been conducted.

This edge computing technology is intended to perform low-latency data processing on a geographically close object. However, processing of low-latency data between geographically distant areas is not yet taken into consideration. That is, device access or data processing within an edge area may guarantee a higher response speed, but interaction performed by mutually connecting edge areas does not guarantee a response speed sufficient to provide immersion. This becomes severe as the geographical distance increases.

Therefore, there are many cases where various services such as smart factories and remote surgery adopt an edge computing architecture to reduce a response time within an operational space.

However, the above-described services will be expanded in a form in which services are used via remote access between edge areas. In this case, a latency (delay) problem may occur when multimodal data including visual, auditory, and tactile data is transmitted in real time. That is, a multimodal experience service of providing visual, auditory, and tactile sensations through a device at a geographically distant location, such as an integrated virtual environment and a remote service, may cause physical constraints such as data latency as the distance to a remote place increases, thus making a user feel discomfort.

Therefore, there is required technology for efficient data processing between a remote edge and a local edge, which can guarantee a response speed between geographically distant edge areas.

### SUMMARY OF THE INVENTION

An embodiment is intended to allow a user to experience multimodal interaction through a device without feeling discomfort by guaranteeing transmission/reception response speeds between geographically distant edges.

In accordance with an aspect of the present disclosure, there is provided an edge server, including memory configured to store at least one program, and a processor configured to execute the program, wherein the program is configured to create a virtual device based on specification information of an actual device and provide the specification information used to create the virtual device in response to a request received from an additional edge server, or acquire specification information used to create a virtual device of the additional edge server in response to a request of the actual device and create a virtual device based on the acquired specification information, wherein the virtual device synchronizes data with the actual device and the virtual device of the additional edge server in real time.

The specification information may include information for resource and real-time synchronization for the actual device synchronized with the virtual device in real time.

The virtual device may be created to include at least one virtual device, and the program may be configured to manage a list of the at least one virtual device and periodically check a state of each of the at least one virtual device included in the list.

The program may be configured to delete or update the corresponding virtual device based on a result of checking the state of each of the at least one virtual device.

The virtual device may transfer real-time data to the virtual device present in an additional edge while synchronizing real-time data with the actual device.

The virtual device may transfer real-time data to the actual device while synchronizing data with the virtual device present in an additional edge in real time.

The virtual device may include a buffer configured to store device data received from the actual device or the virtual device of an additional edge.

In accordance with another aspect of the present disclosure, there is provided a method for virtual device mirroring between edges, including creating a virtual device based on specification information of an actual device, providing the specification information used to create the virtual device in response to a request received from an additional edge server, and performing real-time mirroring with a virtual device created in an additional edge through the created virtual device.

The specification information may include information for resource and real-time synchronization for the actual device synchronized with the virtual device in real time.

The virtual device may be created to include at least one virtual device, and the method may further include managing a list of at least one virtual device and periodically checking a state of each of the at least one virtual device included in the list.

The method may further include deleting or updating the corresponding virtual device based on a result of checking the state of each of the at least one virtual device.

In performing mirroring, the virtual device may transfer real-time data synchronized with the actual device to the virtual device present in the additional edge.

The virtual device may store device data received from the actual device or the virtual device of the additional edge in a buffer.

In accordance with a further aspect of the present disclosure, there is provided a method for virtual device mirroring between edges, including acquiring specification information used to create a virtual device of an additional edge server in response to a request of an actual device, creating a virtual device based on the acquired specification information, and performing real-time mirroring with the virtual device created in an additional edge through the created virtual device.

The specification information may include information for resource and real-time synchronization for the actual device synchronized with the virtual device in real time.

The virtual device may be created to include at least one virtual device, and the method may further include managing a list of at least one virtual device and periodically checking a state of each of the at least one virtual device included in the list.

The method may further include deleting or updating the corresponding virtual device based on a result of checking the state of each of the at least one virtual device.

In performing mirroring, the virtual device may transfer real-time data synchronized with the virtual device present in the additional edge to the actual device.

The virtual device may include a buffer configured to store device data received from the actual device or the virtual device of an additional edge.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating an example of an existing process for transmitting/receiving multimodal data between long distance edges;

FIG. 2 is a diagram illustrating another example of an existing process for transmitting/receiving multimodal data between long distance edges;

FIG. 3 is a configuration diagram of a system including an apparatus for virtual device mirroring between edges according to an embodiment;

FIG. 4 is a block diagram illustrating the internal configuration of each edge server according to an embodiment;

FIG. 5 is a signal flowchart for explaining a method for virtual device mirroring between edges according to an embodiment; and

FIG. 6 is a diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

Device twin technology, which was proposed by Microsoft Azure, refers to technology for defining the states and conditions of devices as digital data (JSON format documents) in an edge computing platform and for synchronizing data with the actual device in a one-to-one correspondence (1:1) in order to efficiently manage numerous devices within edge areas.

By means of this device twin technology, Internet-of-Things (IoT) devices having characteristics, such as an embedded system, remote locations, wireless connection, and battery-based power, may be more efficiently handled.

Edge computing has been utilized as technology for guaranteeing a real-time service, which is the disadvantage of the existing cloud service, by moving data calculation and service support based on data calculation from the cloud to the edge.

Based on the development of edge computing and IoT devices, the range of the edge computing service has expanded from existing data analysis to advanced applications using Artificial Intelligence (AI). Cisco predicts that, by 2023, globally 8.7 billion diverse mobile devices will establish 4.4 billion connections, thus gradually increasing the importance of edge computing technology.

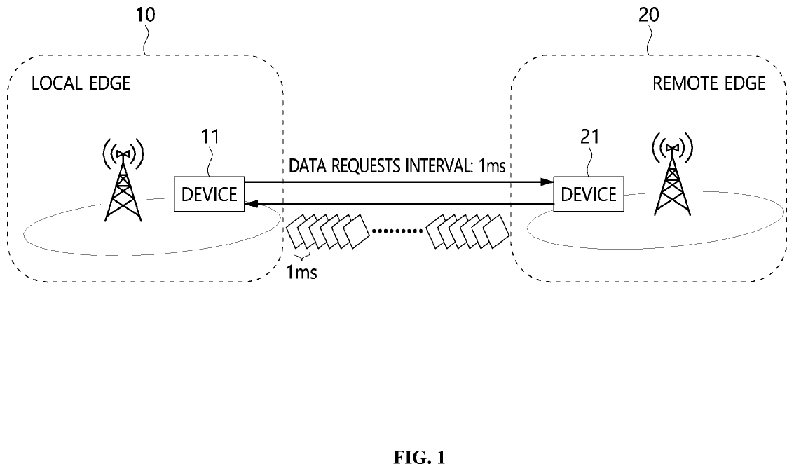

FIG. 1 is a diagram illustrating an example of an existing process for transmitting/receiving multimodal data between long distance edges.

Referring to FIG. 1, edges 10 and 20 may be respectively configured in geographically independent spaces. Of the edges, an edge which requests and receives data for multimodal experience is referred to as a local edge 10, and an edge which transmits multimodal data of the actual device in response to a data request received from the local edge 10 is referred to as a remote edge 20.

However, research into haptic techniques using various technologies based on ultrasonic waves, such as Mid-air and Magnetorheological Fluid (MR Fluid), for multimodal interaction fields in a Virtual Reality (VR) environment is being conducted. In 2014, ITU introduced the concept of the Tactile Internet, defining a data response time of 1 ms for various technologies stemming from the advancement of IoT devices, for example, industries, remote healthcare, Virtual Reality/Augmented Reality (VR/AR), and smart cities.

The reason for this is that, when a response time is delayed during human interaction, humans begin to feel discomfort. For example, humans begin to feel discomfort when a response time for a touch screen is above 1 second, an auditory response time is above 100 ms, a visual response time is above 10 ms, and a tactile response time is above 1 ms.

In FIG. 1, the case where the local edge 10 successfully receives multimodal data from the remote edge 20 with a response time of 1 ms is illustrated.

However, network latency attributable to the distance inevitably occurs in communication and interaction between a user device and an object device between physical edge areas which are geographically distant.

Tactile Internet has been proposed as network technology proposed for the smooth operation of various services including autonomous driving, remote device control, haptic feedback, remote healthcare and surgery, interaction in the metaverse, etc., which are being highlighted with the pandemic and the recent development of edge computing. The Tactile Internet requires a maximum of 2 ms or less as the Round Trip Time (RTT), that is, the time it takes to transmit a request at a remote place and receive a packet as a response to the remote request. With the speed of light, which is 300,000 km per hour, the round-trip time between Korea and the United States, which are 10,000 km apart, is 66 ms, and thus long-distance communication, such as between Korea and the United States, encounters a physical limitation in response time.

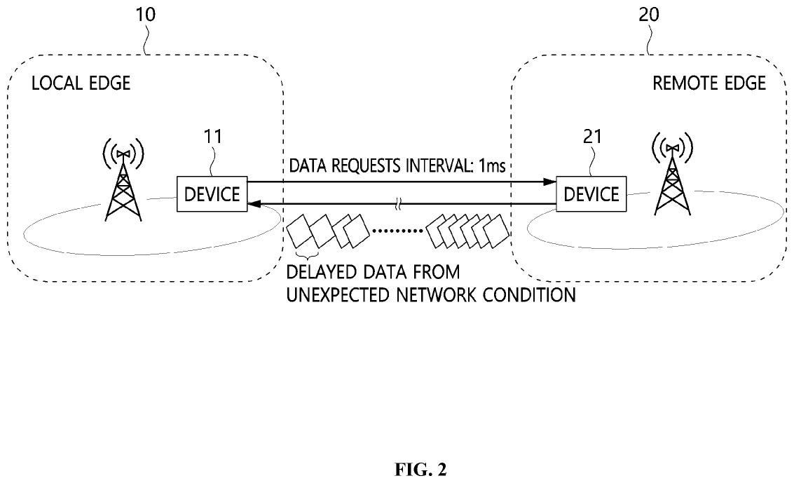

FIG. 2 is a diagram illustrating another example of an existing process for transmitting/receiving multimodal data between long distance edges.

Referring to FIG. 2, the case is illustrated where, as described above, data latency (delay) and loss occurs depending on the geographical situation or unexpected network condition, whereby the user of the local edge 10 may feel discomfort.

Therefore, in an embodiment, synchronized virtual devices are located in edge servers respectively deployed in geographically distant edge areas, and thus the above-described problem of the response time (speed) may be solved. That is, when data is transmitted between geographically distant edges, mirroring technology for copying a virtual device at a remote place to a local edge and for synchronizing the virtual devices with each other in real time is used to minimize the user's discomfort.

This technology enables a device present in the local edge (i.e., a local edge device) to request data from the virtual device that is present in the same edge and that is mirrored with the remote place in real time. Because the local edge device requests data from the copied remote virtual device present in the same edge, rather than directly requesting data from a device in the remote edge that is geographically distant, a fast data response may be guaranteed, and better user experience in multimodal data may be provided. Further, there is an advantage in that the number of steps required for data transmission and synchronization may be increased by locating virtual devices in the local edge device and the remote edge device. This configuration multiplexes points capable of responding to unexpected errors when the unexpected errors occur, and enables temporary connection failures to be supplemented using these points, thus improving system robustness.

The synchronized virtual devices are configured through a combination of real-time synchronization modules between edges with a device twin structure in which the real-time state and data of the actual device is synchronized in real time.

The virtual devices are created in both the local edge and the remote edge when a request for data synchronization and transmission between edge servers deployed in long-distance edge areas is made. Since real-time data of the remote edge device is synchronized, the virtual devices have a similar effect as to deploying the remote edge device in the local edge. Such a technology for virtual device synchronization between long-distance edges is defined as “device mirroring” in the present disclosure.

When a user experiences interaction sensitive to a response time such as visual, auditory, and tactile sensations through the device of the remote edge in the local edge, mirrored virtual device technology defined in the present disclosure is utilized. A user device present in the local edge requests multimodal interaction from a mirrored virtual device present in the local edge, rather than directly requesting multimodal interaction from the remote edge device. Here, because a data response speed is identical to that in the case where data is requested within the local edge, the user may experience visual, auditory, and tactile sensations at a geographically distant place, without feeling discomfort.

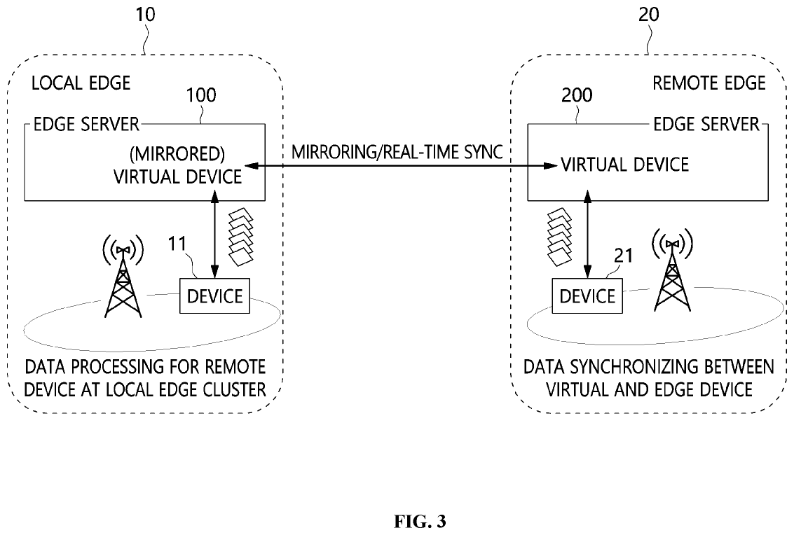

FIG. 3 is a configuration diagram of a system including an apparatus for virtual device mirroring between edges according to an embodiment.

Referring to FIG. 3, apparatuses 100 and 200 for virtual device mirroring between edges (hereinafter referred to as “edge servers”) may be located in respective areas of a local edge 10 and a remote edge 20.

Here, because the edge servers 100 and 200 each have a higher data processing speed and a larger transmission bandwidth than those of actual devices 11 and 21, more stable real-time data synchronization may be performed compared to direct data synchronization between the actual devices 11 and 21.

Therefore, the edge servers 100 and 200 according to the embodiment may create and drive virtual devices therein, respectively.

Here, each virtual device may be software (SW) which synchronizes data in real time with the actual device and the virtual device of the other edge server.

That is, when the local edge 10 processes data from the actual device in the geographically distant remote edge 20, the virtual device present in the edge server 200 of the remote edge is copied to the edge server 100 of the local edge, after which the virtual devices are synchronized with each other in real time.

Then, the actual device of the local edge 10 may transmit/receive data to/from the actual device 21 of the remote edge 20 using the mirrored virtual device present in the edge server 100.

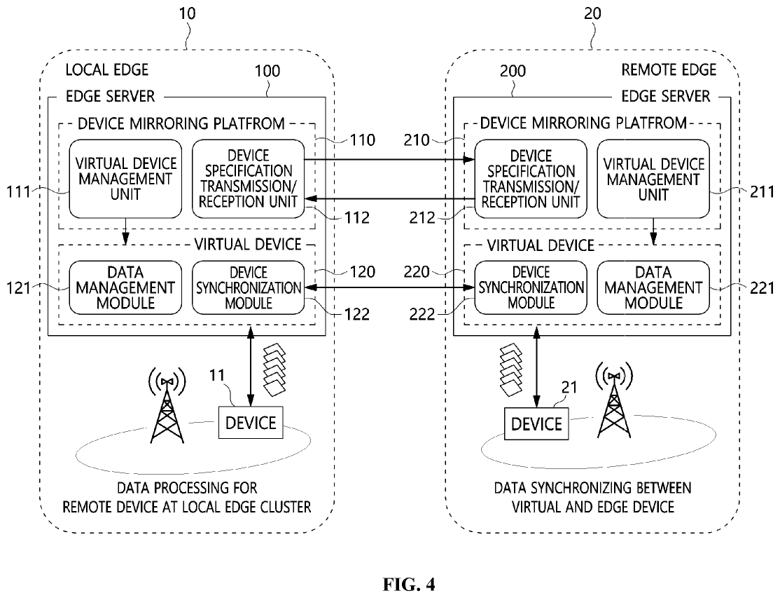

FIG. 4 is a block diagram illustrating the internal configuration of each edge server according to an embodiment.

Referring to FIG. 4, the edge servers 100 and 200 may include device mirroring platforms 110 and 210 which create and manage virtual devices 120 and 220, respectively.

In detail, the device mirroring platforms 110 and 210 may include respective virtual device management units 111 and 211 which create virtual devices through device specifications, and respective device specification transmission/reception units 112 and 212 which provide specifications for mirroring the corresponding virtual devices to external edges.

The virtual device management units 111 and 211 perform creation, deletion, and update of the corresponding virtual devices based on the device specifications received from the device specification transmission/reception units 112 and 212, respectively.

Here, specification information may include information about resources and real-time synchronization of the actual devices 11 and 21 which are synchronized in real time with the virtual devices 120 and 220.

Here, as each virtual device, at least one virtual device may be created.

Each of the virtual device management units 111 and 211 may manage a list of at least one virtual device, and may periodically check the state of the at least one virtual device included in the list.

Here, based on the result of checking the state of each of the at least one virtual device, the corresponding virtual device may be deleted or updated.

Each of the device specification transmission/reception units 112 and 212 may communicate with the device specification transmission/reception unit 212 or 112 of the other edge to transmit/receive virtual device information for mirroring.

Here, when virtual device mirroring is required, each of the device specification transmission/reception units 112 and 212 receives virtual device specification for mirroring from the device specification transmission/reception unit 212 or 112 located in the other edge, and transfers the received virtual device specification to the virtual device management unit 111 or 211.

Meanwhile, the virtual devices 120 and 220 may include respective data management modules 121 and 221 and respective device synchronization modules 122 and 222.

Each of the device synchronization modules 122 and 222 is a module for synchronizing the virtual device with the actual device and synchronizing the virtual device with a mirrored virtual device in real time. The virtual device present in the local edge synchronizes device data with the actual device in real time, and transfers real-time data to the virtual device present in the remote edge. The virtual device present in the remote edge synchronizes data with the virtual device present in the local edge in real time, and provides the corresponding data to the actual device.

Each of the data management modules 121 and 221 manages device data received from the actual device or the virtual device of the remote edge.

Here, each of the data management modules 121 and 221 may include a buffer which stores device data received from the actual device or the virtual device of the other edge. This means that a buffer (temporary storage) may be located in each data management module in order to minimize the user′ discomfort when an unexpected condition between edge servers occurs and it is difficult to guarantee a synchronization time for data sensitive to a response time, for example, sensation information such as visual, auditory, and tactile information.

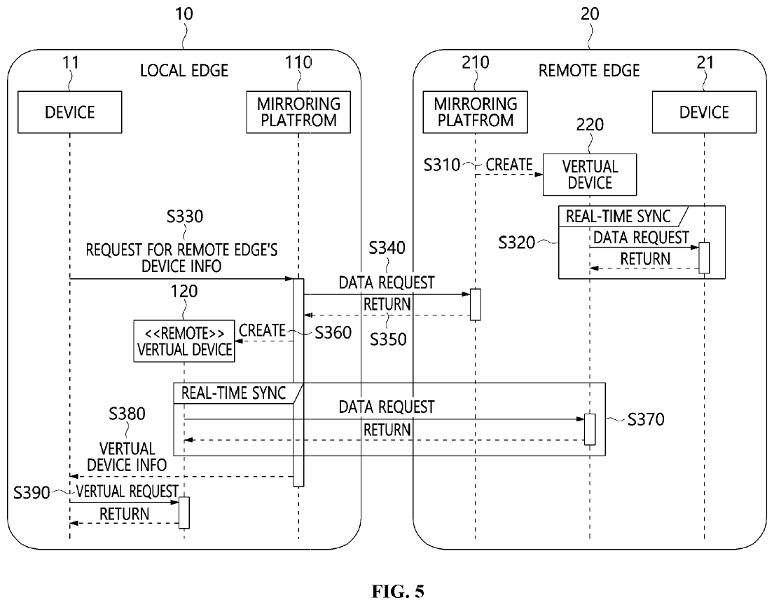

FIG. 5 is a signal flowchart for explaining a method for virtual device mirroring between edges according to an embodiment.

Referring to FIG. 5, the mirroring platform 210 of the remote edge 20 creates a virtual device 220 based on specification information of the actual device 21 at step S310.

Here, the specification information may include information required for resources and real-time synchronization of the actual device 21 which is synchronized with the virtual device in real time.

Here, the virtual device performs real-time synchronization with the actual device 21 at step S320.

Meanwhile, in response to the request of the actual device 11 in the local edge 10 at step S330, the mirroring platform 110 requests the specification information used to create the virtual device from the mirroring platform 210 in the remote edge 20 at step S340.

Then, the mirroring platform 210 of the remote edge 20 provides the specification information used to create the virtual device to the mirroring platform 110 of the local edge 10 at step S350.

The mirroring platform 110 of the local edge 10 creates a virtual device based on the acquired specification information at step S360.

Next, the virtual device created in the local edge 10 may perform real-time synchronization with the virtual device created in the remote edge 20 at step S370.

In this case, each virtual device may store synchronized device data in a buffer.

Next, the mirroring platform 110 of the local edge 10 may transfer the information about the created virtual device to the actual device 11 at step S380, and the actual device 11 may request and acquire synchronization information stored in the virtual device from the virtual device at step S390.

Meanwhile, as each virtual device, at least one virtual device may be created. Therefore, each of the mirroring platforms 110 and 210 may manage a list of the at least one virtual device, and may periodically check the state of each of the at least one virtual device included in the list.

Here, based on the result of checking the state of each of the at least one virtual device, the corresponding virtual device may be deleted or updated.

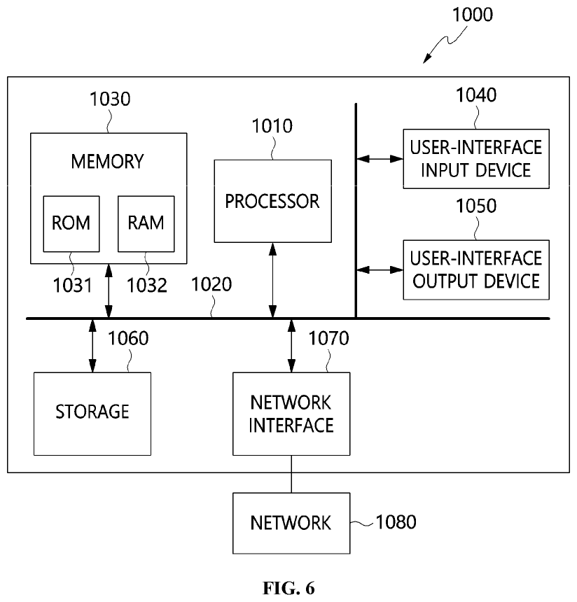

FIG. 6 is a diagram illustrating the configuration of a computer system according to an embodiment.

An edge server according to an embodiment may be implemented in a computer system 1000 such as a computer-readable storage medium.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium or an information delivery medium, or a combination thereof. For example, the memory 1030 may include Read-Only Memory (ROM) 1031 or Random Access Memory (RAM) 1032.

According to the disclosed embodiment, it may be allow a user to experience multimodal interaction through a device without feeling discomfort by guaranteeing transmission/reception response speeds between geographically distant edges.

Although the embodiments of the present disclosure have been disclosed with reference to the attached drawing, those skilled in the art will appreciate that the present disclosure can be implemented in other concrete forms, without changing the technical spirit or essential features of the disclosure. Therefore, it should be understood that the foregoing embodiments are merely exemplary, rather than restrictive, in all aspects.

What is claimed is:

1. An edge server, comprising:
a memory configured to store at least one program; and
a processor configured to execute the program,
wherein the program is configured to:
create a virtual device based on specification information of an actual device and provide the specification information used to create the virtual device in response to a request received from an additional edge server, or
acquire specification information used to create a virtual device of the additional edge server in response to a request of the actual device and create a virtual device based on the acquired specification information, and
wherein the virtual device synchronizes data with the actual device and the virtual device of the additional edge server in real time.

2. The edge server of claim 1, wherein the specification information includes information for resource and real-time synchronization for the actual device synchronized with the virtual device in real time.

3. The edge server of claim 1, wherein:
the virtual device is created to include at least one virtual device, and
the program is configured to manage a list of the at least one virtual device and periodically check a state of each of the at least one virtual device included in the list.

4. The edge server of claim 3, wherein the program is configured to delete or update the corresponding virtual device based on a result of checking the state of each of the at least one virtual device.

5. The edge server of claim 1, wherein the virtual device transfers real-time data to the virtual device present in an additional edge while synchronizing real-time data with the actual device.

6. The edge server of claim 1, wherein the virtual device transfers real-time data to the actual device while synchronizing data with the virtual device present in an additional edge in real time.

7. The edge server of claim 1, wherein the virtual device comprises:
a buffer configured to store device data received from the actual device or the virtual device of an additional edge.

8. A method for virtual device mirroring between edges, comprising:
creating a virtual device based on specification information of an actual device;
providing the specification information used to create the virtual device in response to a request received from an additional edge server; and
performing real-time mirroring with a virtual device created in an additional edge through the created virtual device.

9. The method of claim 8, wherein the specification information includes information for resource and real-time synchronization for the actual device synchronized with the virtual device in real time.

10. The method of claim 8, wherein:
the virtual device is created to include at least one virtual device, and
the method further comprises:
managing a list of at least one virtual device and periodically checking a state of each of the at least one virtual device included in the list.

11. The method of claim 10, further comprising:
deleting or updating the corresponding virtual device based on a result of checking the state of each of the at least one virtual device.

12. The method of claim 8, wherein, in performing mirroring, the virtual device transfers real-time data synchronized with the actual device to the virtual device present in the additional edge.

13. The method of claim 8, wherein the virtual device stores device data received from the actual device or the virtual device of the additional edge in a buffer.

14. A method for virtual device mirroring between edges, comprising:
acquiring specification information used to create a virtual device of an additional edge server in response to a request of an actual device;
creating a virtual device based on the acquired specification information; and
performing real-time mirroring with the virtual device created in an additional edge through the created virtual device.

15. The method of claim 14, wherein the specification information includes information for resource and real-time synchronization for the actual device synchronized with the virtual device in real time.

16. The method of claim 14, wherein:
the virtual device is created to include at least one virtual device, and
the method further comprises:
managing a list of at least one virtual device and periodically checking a state of each of the at least one virtual device included in the list.

17. The method of claim 16, further comprising:
deleting or updating the corresponding virtual device based on a result of checking the state of each of the at least one virtual device.

18. The method of claim 14, wherein, in performing mirroring, the virtual device transfers real-time data synchronized with the virtual device present in the additional edge to the actual device.

19. The method of claim 14, wherein the virtual device comprises:
a buffer configured to store device data received from the actual device or the virtual device of an additional edge.
